(19) United States
(12) Patent Application Publication
(10) Pub. No.: US 2008/0245517 A1
(43) Pub. Date: Oct. 9, 2008

(54) Heat exchanger plate and manufacturing method therefor

(76) Inventors: Soichiro Ishikawa, Mihara (JP); Haretaro Hidaka, Mihara (JP); Seiji Matsushima, Mihara (JP)

Correspondence Address: WENDEROTH, LIND & PONACK, L.L.P., 2033 K STREET N. W., SUITE 800, WASHINGTON, DC, 20006-1021, US

(21) Appl. No.: 11/902,342

(22) Filed: Sep. 20, 2007

(30) Foreign Application Priority Data
Apr. 6, 2007 (JP) 2007-100699

(51) Int. Cl. B23K 20/12; F28F 3/12

(52) U.S. Cl. 165/169; 228/112.1

(57) ABSTRACT

In a heat exchanger plate freedom of design of the flow channel is improved. A flat main body on a surface of which is formed at least one first groove having a rectangular cross-sectional shape, and a second groove having a rectangular cross-sectional shape that is narrower than the first groove, and that is formed following along opposite side faces of the first groove at a center of a bottom face of the first groove; and a flat cover which covers an entire surface of the main body, and on a rear face of which is formed a protrusion whose top face contacts a bottom face of the first groove and whose opposite side faces contact opposite side faces of the first groove, when the cover is superposed on the surface of the main body, and which forms a flow channel by means of a top face thereof and the second groove, are joined by friction stir welding.

### BACKGROUND OF THE INVENTION

1. Field of the Invention

The present invention relates to a heat exchanger plate comprising flow channels through which a cooling medium or heating medium passes, and a manufacturing method therefor.

2. Description of Related Art

One example of a heat exchanger plate comprising flow channels through which a cooling medium or heating medium passes, is a backing plate used to hold a target material during a sputtering process of a liquid crystal manufacturing device (for example Japanese Patent No. 3,818,084).

However, in the invention disclosed in Japanese Patent No. 3,818,084, it is necessary to precisely produce a cover which is fitted to inside a second groove, and seals (covers) the top of a first groove which forms a flow channel (coolant flow channel). Therefore there is a problem in that only a comparatively simple shape (U shape, I shape, S shape or the like) can be employed as the plan view shape of the flow channel, so that there are stringent constraints from the point of designing the flow channel, and freedom of design of the flow channel is significantly limited.

### BRIEF SUMMARY OF THE INVENTION

In accordance with the above circumstances, an object of the present invention is to provide a heat exchanger plate in which freedom of design of the flow channel can be improved, and a manufacturing method therefor.

In order to resolve these problems, the present invention employs the following means.

A manufacturing method for a heat exchanger plate according to the present invention comprises joining by friction stir welding: a flat main body on a surface of which is formed at least one first groove having a rectangular cross-sectional shape, and a second groove having a rectangular cross-sectional shape that is narrower than the first groove, and that is formed following along opposite side faces of the first groove at a center of a bottom face of the first groove; and a flat cover which covers an entire surface of the main body, and on a rear face of which is formed a protrusion whose top face contacts a bottom face of the first groove and whose opposite side faces contact opposite side faces of the first groove, when the cover is superposed on the surface of the main body, and which forms a flow channel by means of a top face thereof and the second groove.

According to the manufacturing method for a heat exchanger plate according to the present invention, because the protrusion is processed in the rear face of the cover with the same procedure (for example using the same program) as when processing the first groove in the surface of the main body (or the first groove is processed in the surface of the main body with the same procedure as when processing the protrusion in the rear face of the cover), the protrusion (or the first groove) can be precisely processed irrespective of the plan view shape of the protrusion (or the first groove) (irrespective of whatever shape the plan view shape of the protrusion (or the first groove) takes)), so that there are no constraints from the point of designing the flow channel, and freedom of design of the flow channel can be significantly improved.

A manufacturing method for a heat exchanger plate according to the present invention, comprises joining by friction stir welding: a flat main body on a surface of which is formed at least one groove having an approximately rectangular cross-sectional shape; and a flat cover which covers an entire surface of the main body, and on a rear face of which is formed a protrusion whose opposite side faces contact opposite side faces of the groove, when the cover is superposed on the surface of the main body, and which forms a flow channel by means of a top face thereof, and a bottom face and opposite side faces of the groove.

According to the manufacturing method for a heat exchanger plate according to the present invention, because the protrusion is processed in the rear face of the cover with the same procedure (for example using the same program) as when processing the groove in the surface of the main body (or the groove is processed in the surface of the main body with the same procedure as when processing the protrusion in the rear face of the cover), the protrusion (or the groove) can be precisely processed irrespective of the plan view shape of the protrusion (or the groove) (irrespective of whatever shape the plan view shape of the protrusion (or the groove) takes)), so that there are no constraints from the point of designing the flow channel, and freedom of design of the flow channel can be significantly improved.

Moreover, because the cross-sectional shape of the groove processed into the top face of the main body has the simplest shape (a rectangle), the machine time required to process the groove can be shortened, and production costs can be reduced.

In addition, because the width of the groove, which forms the flow channel, can be increased, the cross-sectional area of the flow channel can be increased.

In the manufacturing method for a heat exchanger plate according to the present invention, more preferably there is further provided a step for producing a notch that is concave inward, on the side faces of the protrusion facing the side faces of the groove when the protrusion is fitted to inside the groove, as at least a single line or a plurality of points along the side faces of the protrusion.

According to this manufacturing method for a heat exchanger plate, at the time of joining the main body and the cover by friction stir welding, the side face of the groove intrudes into the notch interior, and the opposite side faces of the protrusion are reliably (tightly) held by the opposite side faces of the groove. Therefore, the load applied to the cover when the main body and the cover are joined can be transmitted to the main body via the notch and the opposite side faces of the groove, intrusion of the penetration bead of the weld into the flow channel can be prevented, and deformation of the cover resulting from the welding process can be prevented.

A manufacturing method for a heat exchanger plate according to the present invention comprises joining by friction stir welding: a flat main body on a surface of which is formed at least one first groove having an approximate trapezoidal shape in cross-section, and a second groove having a rectangular cross-sectional shape that is further deepened along opposite side faces of the first groove between the side faces of the first groove; and a flat cover which covers an entire surface of the main body, and on a rear face of which is formed a protrusion whose opposite side faces contact the opposite side faces of the first groove, when the cover is superposed on the surface of the main body, and which forms a flow channel by means of a top face thereof and a bottom face and opposite side faces of the second groove.

According to the manufacturing method for a heat exchanger plate according to the present invention, because the protrusion is processed in the rear face of the cover with the same procedure (for example using the same program) as when processing the first groove in the surface of the main body (or the first groove is processed in the surface of the main body with the same procedure as when processing the protrusion in the rear face of the cover), the protrusion (or the first groove) can be precisely processed irrespective of the plan view shape of the protrusion (or the first groove) (irrespective of whatever shape the plan view shape of the protrusion (or the first groove) takes)), so that there are no constraints from the point of designing the flow channel, and freedom of design of the flow channel can be significantly improved.

Also, because the load applied to the cover when the main body and the cover are joined can be directly transmitted to the main body, intrusion of the penetration bead of the weld into the flow channel can be prevented, and deformation of the cover resulting from the welding process can be prevented.

A manufacturing method for a heat exchanger plate according to the present invention comprises joining by friction stir welding: a flat main body on a surface of which is formed at least one first groove having a rectangular cross-sectional shape; and a flat cover which covers an entire surface of the main body, and on a rear face of which is formed a protrusion whose top face contacts a bottom face of the first groove, when the cover is superposed on the surface of the main body, and whose opposite side faces contact opposite side faces of the first groove, and which is provided with a second groove formed following along the opposite side faces at a center of the top face.

According to the manufacturing method for a heat exchanger plate according to the present invention, because the protrusion is processed in the rear face of the cover with the same procedure (for example using the same program) as when processing the first groove in the surface of the main body (or the first groove is processed in the surface of the main body with the same procedure as when processing the protrusion in the rear face of the cover), the protrusion (or the first groove) can be precisely processed irrespective of the plan view shape of the protrusion (or the first groove) (irrespective of whatever shape the plan view shape of the protrusion (or the first groove) takes)), so that there are no constraints from the point of designing the flow channel, and freedom of design of the flow channel can be significantly improved.

Moreover, because the cross-sectional shape of the first groove processed into the top face of the main body has the simplest shape (a rectangle), the machine time required to process the first groove can be shortened, and production costs can be reduced.

Furthermore, because the second groove which forms the flow channel is formed at the center of the top face of the protrusion, the load applied to the cover when the main body and the cover are joined can be transmitted to the bottom face of the first groove, that is the main body, via the edges of the protrusion whose height is substantially equal to the depth of the first groove, intrusion of the penetration bead of the weld into the flow channel can be prevented, and deformation of the cover resulting from the welding process can be prevented.

In addition, because the edges of the protrusion are formed so as to have a height substantially equal to the depth of the first groove, the rigidity of the cover in its entirety can be improved, the width of the second groove can be increased, and the width of the flow channel can be increased, thereby enabling an increase in the cross-sectional area of the flow channel.

In the above manufacturing method for a heat exchanger plate according to the present invention, preferably a step is further provided after joining the main body and the cover, for uniformly grinding and polishing the surface of the cover until the surface of the cover becomes flush with the surface of the main body.

According to this manufacturing method for a heat exchanger plate, because the surface of the cover is uniformly (evenly) ground and polished until the entire surface of the main body is exposed, the overall plate thickness can be reduced.

A heat exchanger plate according to the present invention comprises: a flat main body on a surface of which is formed at least one first groove having a rectangular cross-sectional shape, and a second groove having a rectangular cross-sectional shape that is narrower than the first groove, and that is formed following along opposite side faces of the first groove at a center of a bottom face of the first groove; and a flat cover which covers an entire surface of the main body, and on a rear face of which is formed a protrusion whose top face contacts a bottom face of the first groove and whose opposite side faces contact opposite side faces of the first groove, when the cover is superposed on the surface of the main body, and which forms a flow channel by means of a top face thereof and the second groove, and the cover is joined by friction stir welding to the main body.

According to the heat exchanger plate according to the present invention, because the protrusion is processed in the rear face of the cover with the same procedure (for example using the same program) as when processing the first groove in the surface of the main body (or the first groove is processed in the surface of the main body with the same procedure as when processing the protrusion in the rear face of the cover), the protrusion (or the first groove) can be precisely processed irrespective of the plan view shape of the protrusion (or the first groove) (irrespective of whatever shape the plan view shape of the protrusion (or the first groove) takes)), so that there are no constraints from the point of designing the flow channel, and freedom of design of the flow channel can be significantly improved.

A heat exchanger plate according to the present invention, comprises: a flat main body on a surface of which is formed at least one groove having an approximately rectangular cross-sectional shape; and a flat cover which covers an entire surface of the main body, and on a rear face of which is formed a protrusion whose opposite side faces contact opposite side faces of the groove, when the cover is superposed on the surface of the main body, and which forms a flow channel by means of a top face thereof and a bottom face and opposite side faces of the second groove, and the cover is joined by friction stir welding to the main body.

According to the heat exchanger plate according to the present invention, because the protrusion is processed in the rear face of the cover with the same procedure (for example using the same program) as when processing the groove in the surface of the main body (or the groove is processed in the surface of the main body with the same procedure as when processing the protrusion in the rear face of the cover), the protrusion (or the groove) can be precisely processed irrespective of the plan view shape of the protrusion (or the groove) (irrespective of whatever shape the plan view shape of the protrusion (or the groove) takes)), so that there are no constraints from the point of designing the flow channel, and freedom of design of the flow channel can be significantly improved.

Moreover, because the cross-sectional shape of the groove processed into the top face of the main body has the simplest shape (a rectangle), the machine time required to process the groove can be shortened, and production costs can be reduced.

In addition, because the width of the groove, which forms the flow channel, can be increased, the cross-sectional area of the flow channel can be increased.

In the aforementioned heat exchanger plate, more preferably a notch that is concave inward, is arranged on the side faces of the protrusion facing the side faces of the groove when the protrusion is fitted to inside the groove, as at least a single line or a plurality of points along the side faces of the groove.

According to this heat exchanger plate, at the time of joining the main body and the cover by friction stir welding, the side face of the groove intrudes into the notch interior, and the opposite side faces of the protrusion are reliably (tightly) held by the opposite side faces of the groove. Therefore, the load applied to the cover when the main body and the cover are joined can be transmitted to the main body via the notch and the opposite side faces of the groove, intrusion of the penetration bead of the weld into the flow channel can be prevented, and deformation of the cover resulting from the welding process can be prevented.

A heat exchanger plate according to the present invention comprises: a flat main body on a surface of which is formed at least one first groove having an approximate trapezoidal shape in cross-section, and a second groove having a rectangular cross-sectional shape that is further deepened along opposite side faces of the first groove between the side faces of the first groove; and a flat cover which covers an entire surface of the main body, and on a rear face of which is formed a protrusion whose opposite side faces contact the opposite side faces of the first groove, when the cover is superposed on the surface of the main body, and which forms a flow channel by means of a top face thereof and a bottom face and opposite side faces of the second groove, and the cover is joined by friction stir welding to the main body.

According to the heat exchanger plate according to the present invention, because the protrusion is processed in the rear face of the cover with the same procedure (for example using the same program) as when processing the first groove in the surface of the main body (or the first groove is processed in the surface of the main body with the same procedure as when processing the protrusion in the rear face of the cover), the protrusion (or the first groove) can be precisely processed irrespective of the plan view shape of the protrusion (or the first groove) (irrespective of whatever shape the plan view shape of the protrusion (or the first groove) takes)), so that there are no constraints from the point of designing the flow channel, and freedom of design of the flow channel can be significantly improved.

Also, because the load applied to the cover when the main body and the cover are joined can be directly transmitted to the main body, intrusion of the penetration bead of the weld into the flow channel can be prevented, and deformation of the cover resulting from the welding process can be prevented.

A heat exchanger plate according to the present invention comprises: a flat main body on a surface of which is formed at least one first groove having a rectangular cross-sectional shape; and a flat cover which covers an entire surface of the main body, and on a rear face of which is formed a protrusion whose top face contacts a bottom face of the first groove, when the cover is superposed on the surface of the main body, and whose opposite side faces contact opposite side faces of the first groove, and in the cover there is provided a second groove formed following along the opposite side faces at a center of the top face, and the cover is joined by friction stir welding to the main body.

According to the heat exchanger plate according to the present invention, because the protrusion is processed in the rear face of the cover with the same procedure (for example using the same program) as when processing the first groove in the surface of the main body (or the first groove is processed in the surface of the main body with the same procedure as when processing the protrusion in the rear face of the cover), the protrusion (or the first groove) can be precisely processed irrespective of the plan view shape of the protrusion (or the first groove) (irrespective of whatever shape the plan view shape of the protrusion (or the first groove) takes)), so that there are no constraints from the point of designing the flow channel, and freedom of design of the flow channel can be significantly improved.

Moreover, because the cross-sectional shape of the first groove processed into the top face of the main body has the simplest shape (a rectangle), the machine time required to process the first groove can be shortened, and production costs can be reduced.

Furthermore, because the second groove which forms the flow channel is formed at the center of the top face of the protrusion, the load applied to the cover when the main body and the cover are joined can be transmitted to the bottom face of the first groove, that is the main body, via the edges of the protrusion whose height is substantially equal to the depth of the first groove, intrusion of the penetration bead of the weld into the flow channel can be prevented, and deformation of the cover resulting from the welding process can be prevented.

In addition, because the edges of the protrusion are formed so as to have a height substantially equal to the depth of the first groove, the rigidity of the cover in its entirety can be improved, the width of the second groove can be increased, and the width of the flow channel can be increased, thereby enabling an increase in the cross-sectional area of the flow channel.

According to the present invention, there is the effect that freedom of design of the flow channel can be improved.

### BRIEF DESCRIPTION OF THE SEVERAL VIEWS OF THE DRAWINGS

FIG. 1 is a schematic plan view of a heat exchanger plate according to a first embodiment of the present invention.

FIG. 2 is a partial cross-sectional view of FIG. 1.

FIG. 3 is a similar figure to FIG. 2, showing a partial cross-sectional view of a heat exchanger plate according to a second embodiment of the present invention.

FIG. 4 is a similar figure to FIG. 2 and FIG. 3, showing a partial cross-sectional view of a heat exchanger plate according to a third embodiment of the present invention.

FIG. 5 is a similar figure to FIG. 2 through FIG. 4, showing a partial cross-sectional view of a heat exchanger plate according to a fourth embodiment of the present invention.

FIG. 6 is a similar figure to FIG. 2 through FIG. 5, showing a partial cross-sectional view of a heat exchanger plate according to a fifth embodiment of the present invention.

### DETAILED DESCRIPTION OF THE INVENTION

Embodiments of the present invention are described below with reference to the drawings.

### First Embodiment

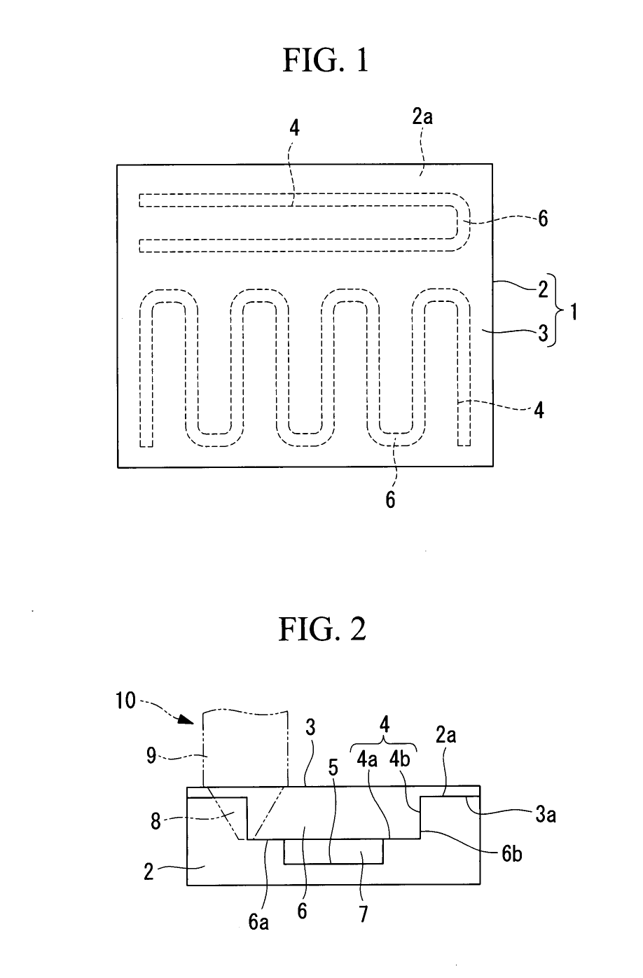

A first embodiment of a heat exchanger plate according to the present invention is described below with reference to FIG. 1 and FIG. 2. FIG. 1 is a schematic plan view of a heat exchanger plate according to the present embodiment, and FIG. 2 is a partial cross-sectional view of FIG. 1. In order to simplify the figures, the outline of the second groove 5 is omitted in FIG. 1.

As shown in FIG. 1, the heat exchanger plate (referred to hereafter as “backing plate”) 1 according to the present embodiment comprises a main body 2 and a cover 3.

The main body 2, for example, is a flat member produced from oxygen-free copper or a copper alloy containing 5% or less Zr or Cr, having a rectangular shape in plan view which is approximately 2350 mm long, 2010 mm wide, and 15 mm deep. Furthermore, a groove 4 furnished with a bottom face 4a and side faces 4b, being a (first) groove 4 having a U-shape in plan view and a rectangular shape in cross-section, and/or a groove 4 having a wave shape in plan view and a rectangular shape in cross-section is provided in a top face (surface) 2a of this main body 2. Moreover, a (second) groove 5 having a rectangular cross-sectional shape that is narrower than the first groove 4, and that is formed following along the opposite side faces 4b of the first groove 4, is provided at a center of the bottom face 4a of the first groove 4.

The cover 3 is a flat member having a rectangular shape in plan view which is approximately 2350 mm long, and 2010 mm wide, and covers the entire surface 2a of the main body 2. Moreover, on an under surface (rear face) 3a of the cover 3 is formed a protrusion 6 such that its top face 6a contacts the bottom face 4a of the groove 4 and its opposite side faces 6b contact the opposite side faces 4b of the groove 4, when the cover 3 is superposed on the surface 2a of the main body 2. In addition a void formed when the protrusion 6 is engaged in the groove 4 (more specifically the void enclosed by the groove 5 and the top face 6a of the protrusion 6) serves as a flow channel 7 through which a cooling medium or heating medium passes.

The main body 2 and the cover 3 are joined by friction stir welding (FSW). Friction stir welding is a welding method that involves inserting a rotating tool 10 comprising a shoulder section 8 and a pin section 9 as shown in FIG. 2, into the joint (boundary: joint line) between the main body 2 and the cover 3, which extends in the plate thickness direction, and rotating the rotating tool 10 as it moves along the joint.

Furthermore, when the main body 2 and the cover 3 are joined by friction stir welding, a plurality (2 in the present embodiment) of independent flow channels 7 are formed in the backing plate 1 (the flow channel 7 formed between the groove 5 having a U shape in plan view and the top face 6a of the protrusion 6 having a U shape in plan view, and the flow channel 7 formed between the groove 5 having a wave shape in plan view and the top face 6a of the protrusion 6 having a wave shape in plan view). Furthermore, after the welding process, an inlet for the cooling or heating medium is provided at one end of each flow channel 7, and an outlet for the cooling or heating medium is provided at the other end.

According to the backing plate 1 according to the present embodiment, because the protrusion 6 is processed on the under surface 3a of the cover 3 with the same procedure (for example using the same program) as when processing the groove 4 in the surface 2a of the main body 2 (or the groove 4 is processed in the surface 2a of the main body 2 with the same procedure as when processing the protrusion 6 on the under surface 3a of the cover 3), the protrusion 6 (or the groove 4) can be precisely processed irrespective of the plan view shape of the protrusion 6 (or the groove 4) (irrespective of whatever shape the plan view shape of the protrusion 6 (or the groove 4) takes)), so that there are no constraints from the point of designing the flow channel 7, and freedom of design of the flow channel can be significantly improved.

In this embodiment, after joining the main body 2 and the cover 3, the top face (surface) of the cover 3 is uniformly (evenly) ground and polished until the entire surface 2a of the main body 2 is exposed, that is, until the top face of the cover 3 becomes flush with the top face 2a of the main body 2 (forms a coplanar surface). This process can also be used to reduce the overall plate thickness.

### Second Embodiment

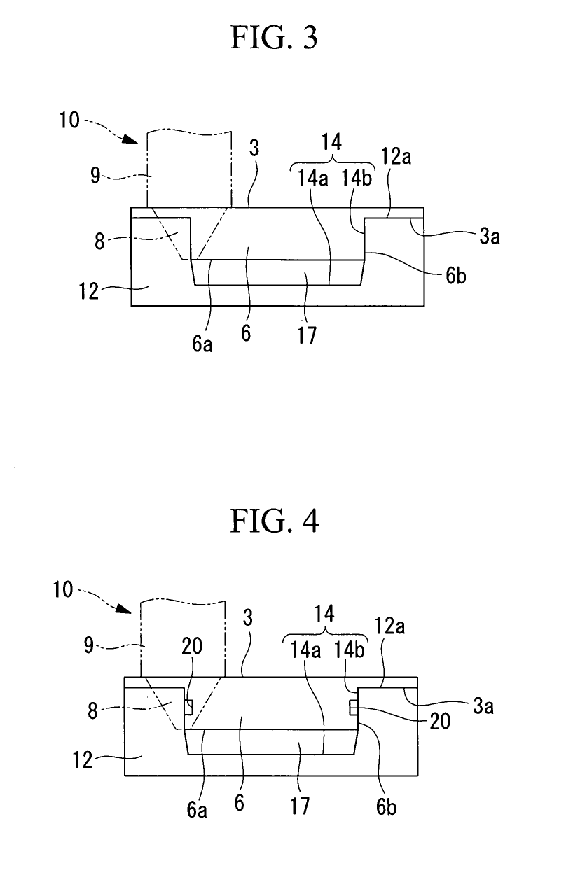

A second embodiment of a backing plate according to the present invention is described with reference to FIG. 3. FIG. 3 is a similar figure to FIG. 2 showing a partial cross-sectional view of a backing plate according to the present embodiment.

The backing plate according to the present embodiment differs from that of the first embodiment described above in that a main body 12 is provided instead of the main body 2.

Those members the same as in the first embodiment are denoted by the same reference symbols.

The main body 12, for example, is a flat member produced from oxygen-free copper or a copper alloy containing 5% or less Zr or Cr, having a rectangular shape in plan view which is approximately 2350 mm long, 2010 mm wide, and 15 mm deep. Furthermore, a groove 14 furnished with a bottom face 14a and side faces 14b, being a groove 14 having a U-shape in plan view and an approximately rectangular shape in cross section, and/or a groove 14 having a wave shape in plan view and an approximately rectangular shape in cross section is provided in a top face (surface) 12a of this main body 12. Furthermore, the groove 14 is milled (engraved) so that its depth (more specifically, the height of the side walls 14b) is greater than the height of the protrusion 6.

The cover 3 is a flat member having a rectangular shape in plan view which is approximately 2350 mm long, and 2010 mm wide, and covers the entire surface 12a of the main body 12. Moreover, on an under surface (rear face) 3a of the cover 3 is formed a protrusion 6 such that when the cover 3 is superposed on the surface 12a of the main body 12, it forms a void of an approximately rectangular cross-sectional shape between its top face 6a and a bottom face 14a of the groove 14, and its opposite side faces 6b contact opposite side faces 14b of the groove 14. In addition the void formed when the protrusion 6 is engaged in the groove 14 (more specifically the void enclosed by the bottom face 14a and the opposite side faces 14b of the groove 14 and the top face 6a of the protrusion 6) serves as a flow channel 17 through which a cooling medium or heating medium passes.

The main body 12 and the cover 3 are joined by friction stir welding (FSW). Friction stir welding is a welding method that involves inserting a rotating tool 10 comprising a shoulder section 8 and a pin section 9 as shown in FIG. 3, into the joint (boundary: joint line) between the main body 12 and the cover 3, which extends in the plate thickness direction, and rotating the rotating tool 10 as it moves along the joint.

Furthermore, when the main body 12 and the cover 3 are joined by friction stir welding, a plurality (2 in the present embodiment) of independent flow channels 17 are formed in the backing plate (the flow channel 17 formed between the bottom face 14a and the opposite side faces 14b of the groove 14 having a U shape in plan view and the top face 6a of the protrusion 6 having a U shape in plan view, and the flow channel 17 formed between the top face 14a and the opposite side faces 14b of the groove 14 having a wave shape in plan view and the top face 6a of the protrusion 6 having a wave shape in plan view). Furthermore, after the welding process, an inlet for the cooling or heating medium is provided at one end of each flow channel 17, and an outlet for the cooling or heating medium is provided at the other end.

According to the backing plate according to the present embodiment, because the protrusion 6 is processed on the under surface 3a of the cover 3 with the same procedure (for example using the same program) as when processing the groove 14 in the surface 12a of the main body 12 (or the groove 14 is processed in the surface 12a of the main body 12 with the same procedure as when processing the protrusion 6 on the under surface 3a of the cover 3), the protrusion 6 (or the groove 14) can be precisely processed irrespective of the plan view shape of the protrusion 6 (or the groove 14) (irrespective of whatever shape the plan view shape of the protrusion 6 (or the groove 14) takes)), so that there are no constraints from the point of designing the flow channel 17, and freedom of design of the flow channel can be significantly improved.

Moreover, because the cross-sectional shape of the groove 14 processed into the top face 12a of the main body 12 has the simplest shape (an approximately rectangle), the machine time required to process the groove 14 can be shortened, and production costs can be reduced.

In addition, because the width of the groove 14, which forms the flow channel 17, can be increased, the cross-sectional area of the flow channel 17 can be increased.

In this embodiment, after joining the main body 12 and the cover 3, the top face (surface) of the cover 3 is uniformly (evenly) ground and polished until the entire surface 12a of the main body 12 is exposed, that is, until the top face of the cover 3 becomes flush with the top face 12a of the main body 12 (forms a coplanar surface). This process can also be used to reduce the overall plate thickness.

### Third Embodiment

A third embodiment of a backing plate according to the present invention is described with reference to FIG. 4. FIG. 4 is a similar figure to FIG. 2 and FIG. 3 showing a partial cross-sectional view of a backing plate according to the present embodiment.

The backing plate according to the present embodiment differs from that of the second embodiment described above in that a minute notch (groove) 20 that is concave (furrowed) inward (inside), is arranged on the side faces 6b of the protrusion 6 facing the side faces 14b of the groove 14 when the protrusion 6 is fitted to inside the groove 14, as a single line (strip) or a plurality of points along the side faces 6b of the protrusion 6. Other components are the same as in the second embodiment, and hence description of these components is omitted here.

Those members the same as in the second embodiment are denoted by the same reference symbols.

According to the backing plate according to the present embodiment, at the time of joining the main body 12 and the cover 13 by friction stir welding (FSW), the side face 14b of the groove 14 intrudes into (enters into) the notch interior 20, and the opposite side faces 6b of the protrusion 6 are reliably (tightly) held by the opposite side faces 14b of the groove 14. Therefore, the load applied to the cover 3 when the main body 12 and the cover 3 are joined can be transmitted to the main body 12 via the notch 20 and the opposite side faces 14b of the groove 14, intrusion of the penetration bead of the weld into the flow channel 17 can be prevented, and deformation of the cover 3 resulting from the welding process can be prevented.

Other operational effects are the same as in the second embodiment, and hence description of these is omitted here.

In this embodiment, after joining the main body 12 and the cover 3, the top face (surface) of the cover 3 is uniformly (evenly) ground and polished until the entire surface 12a of the main body 12 is exposed, that is, until the top face of the cover 3 becomes flush with the top face 12a of the main body 12 (forms a coplanar surface). This process can also be used to reduce the overall plate thickness.

### Fourth Embodiment

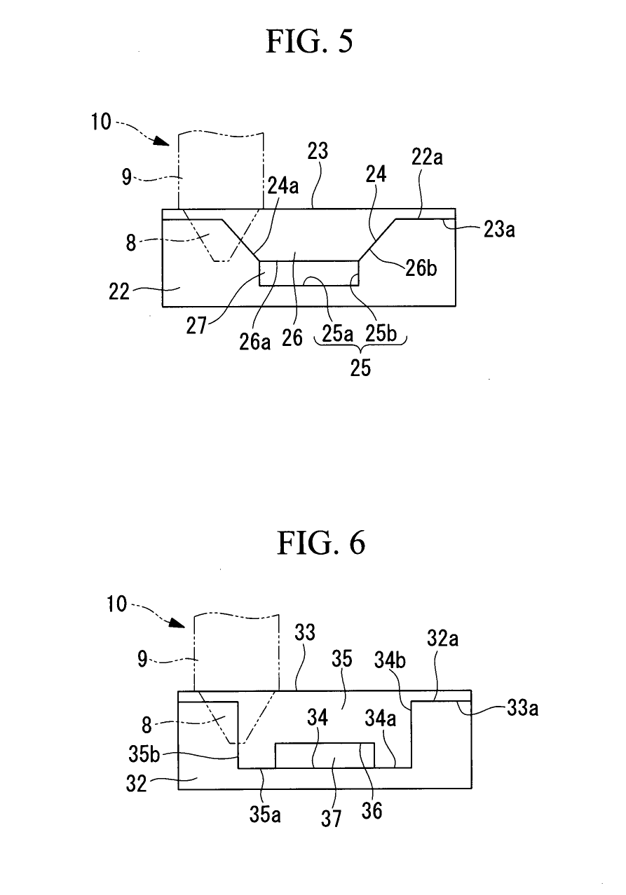

A fourth embodiment of a backing plate according to the present invention is described with reference to FIG. 5. FIG. 5 is a similar figure to FIG. 2 through FIG. 4 showing a partial cross-sectional view of a backing plate according to the present embodiment.

The backing plate according to the present embodiment differs from that of the embodiments described above in that a main body 22 and a cover 23 are provided instead of the main body 2 or 12 and the cover 3.

Those members the same as in the embodiments described above are denoted by the same reference symbols.

The main body 22, for example, is a flat member produced from oxygen-free copper or a copper alloy containing 5% or less Zr or Cr, having a rectangular shape in plan view which is approximately 2350 mm long, 2010 mm wide, and 15 mm deep. Furthermore, a groove 24 furnished with a side face (inclined face) 24a, being a (first) groove 24 having a U-shape in plan view and an approximate trapezoidal shape in cross-section, and/or a groove 24 having a wave shape in plan view and an approximate trapezoidal shape in cross-section is provided in a top face (surface) 22a of this main body 22. Moreover, a (second) groove 25 having a rectangular cross-sectional shape milled (engraved) following along the opposite side faces 24a of the groove 24, is provided between the side faces 24a of the groove 24.

The cover 23 is a flat member having a rectangular shape in plan view which is approximately 2350 mm long, and 2010 mm wide, and covers the entire surface 22a of the main body 22. Moreover, on an under surface (rear face) 23a of the cover 23 is formed a protrusion 26 such that when the cover 23 is superposed on the surface 22a of the main body 22, it forms a void of a rectangular cross-sectional shape between a top face 26a thereof and a bottom face 25a of the groove 25, and opposite side faces 26b thereof contact opposite side faces 24a of the groove 24. In addition the void formed when the protrusion 26 is engaged in the groove 24 (more specifically the void enclosed by the bottom face 25a and the opposite side faces 25b of the groove 25 and the top face 26a of the protrusion 26) serves as a flow channel 27 through which a cooling medium or heating medium passes.

The main body 22 and the cover 23 are joined by friction stir welding (FSW). Friction stir welding is a welding method that involves inserting a rotating tool 10 comprising a shoulder section 8 and a pin section 9 as shown in FIG. 5,into the joint (boundary: joint line) between the main body 22 and the cover 23, which extends in the plate thickness direction, and rotating the rotating tool 10 as it moves along the joint.

Furthermore, when the main body 22 and the cover 23 are joined by friction stir welding, a plurality (2 in the present embodiment) of independent flow channels 27 are formed in the backing plate (the flow channel 27 formed between the bottom face 25a and the opposite side faces 25b of the groove 25 having a U shape in plan view and the top face 26a of the protrusion 26 having a U shape in plan view, and the flow channel 27 formed between the bottom face 25a and the opposite faces 25b of the groove 25 having a wave shape in plan view and the top face 26a of the protrusion 26 having a wave shape in plan view). Furthermore, after the welding process, an inlet for the cooling or heating medium is provided at one end of each flow channel 27, and an outlet for the cooling or heating medium is provided at the other end.

According to the backing plate according to the present embodiment, because the protrusion 26 is processed on the under surface 23a of the cover 23 with the same procedure (for example using the same program) as when processing the groove 24 in the surface 22a of the main body 22 (or the groove 24 is processed in the surface 22a of the main body 22 with the same procedure as when processing the protrusion 26 on the under surface 23a of the cover 23), the protrusion 26 (or the groove 24) can be precisely processed irrespective of the plan view shape of the protrusion 26 (or the groove 24) (irrespective of whatever shape the plan view shape of the protrusion 26 (or the groove 24) takes)), so that there are no constraints from the point of designing the flow channel 27, and freedom of design of the flow channel can be significantly improved.

Also, because the load applied to the cover 23 when the main body 22 and the cover 23 are joined is directly transmitted to the main body 22, intrusion of the penetration bead of the weld into the flow channel 27 can be prevented, and deformation of the cover 23 resulting from the welding process can be prevented.

In this embodiment, after joining the main body 22 and the cover 23, the top face (surface) of the cover 23 is uniformly (evenly) ground and polished until the entire surface 22a of the main body 22 is exposed, that is, until the top face of the cover 23 becomes flush with the top face 22a of the main body 23 (forms a coplanar surface). This process can also be used to reduce the overall plate thickness.

### Fifth Embodiment

A fifth embodiment of a backing plate according to the present invention is described with reference to FIG. 6. FIG. 6 is a similar figure to FIG. 2 through FIG. 5 showing a partial cross-sectional view of a backing plate according to the present embodiment.

The backing plate according to the present embodiment differs from that of the embodiments described above in that a main body 32 and a cover 33 are provided instead of the main body 2, 12, or 22 and the cover 3 or 23.

Those members the same as in the embodiments described above are denoted by the same reference symbols.

The main body 32, for example, is a flat member produced from oxygen-free copper or a copper alloy containing 5% or less Zr or Cr, having a rectangular shape in plan view which is approximately 2350 mm long, 2010 mm wide, and 15 mm deep. Furthermore, a (first) groove 34 having a U-shape in plan view and a rectangular cross-sectional shape, and/or a groove 34 having a wave shape in plan view and a rectangular cross-sectional shape is provided in a top face (surface) 32a of the main body 32.

The cover 33 is a flat member having a rectangular shape in plan view which is approximately 2350 mm long, and 2010 mm wide, and covers the entire surface 32a of the main body 32. Moreover, on an under surface (rear face) 33a of the cover 33 is formed a protrusion 35 such that a top face 35a thereof contacts a bottom face 34a of the groove 34 and its opposite side faces 35b contact opposite side faces 34b of the groove 34, when the cover 33 is superposed on the surface 32a of the main body 32. Furthermore, there is provided a (second) groove 36 having a rectangular cross-sectional shape that is formed following along opposite side faces 35b, at a center of the top face 35a of the protrusion 35. In addition a void formed when the protrusion 35 is engaged in the groove 34 (more specifically the void enclosed by the bottom face 34a of the groove 34, and the groove 36) serves as a flow channel 37 through which a cooling medium or heating medium passes.

The main body 32 and the cover 33 are joined by friction stir welding (FSW). Friction stir welding is a welding method that involves inserting a rotating tool 10 comprising a shoulder section 8 and a pin section 9 as shown in FIG. 6,into the joint (boundary: joint line) between the main body 32 and the cover 33, which extends in the plate thickness direction, and rotating the rotating tool 10 as it moves along the joint.

Furthermore, when the main body 32 and the cover 33 are joined by friction stir welding, a plurality (2 in the present embodiment) of independent flow channels 37 are formed in the backing plate (the flow channel 37 formed between the bottom face 34a of the groove 34 having a U shape in plan view and the groove 36 formed in the top face 35a of protrusion 35 having a U shape in plan view, and the flow channel 37 formed between the bottom face 34a of the groove 34 having a wave shape in plan view and the groove 36 formed in the top face 35a of the protrusion 35 having a wave shape in plan view). Furthermore, after the welding process, an inlet for the cooling or heating medium is provided at one end of each flow channel 37, and an outlet for the cooling or heating medium is provided at the other end.

According to the backing plate according to the present embodiment, because the protrusion 35 is processed on the under surface 33a of the cover 33 with the same procedure (for example using the same program) as when processing the groove 34 in the surface 32a of the main body 32 (or the groove 34 is processed in the surface 32a of the main body 32 with the same procedure as when processing the protrusion 35 on the under surface 33a of the cover 33), the protrusion 35 (or the groove 34) can be precisely processed irrespective of the plan view shape of the protrusion 35 (or the groove 34) (irrespective of whatever shape the plan view shape of the protrusion 35 (or the groove 34) takes)), so that there are no constraints from the point of designing the flow channel 37, and freedom of design of the flow channel can be significantly improved.

Moreover, because the cross-sectional shape of the groove 34 processed into the top face 32a of the main body 32 has the simplest shape (a rectangle), the machine time required to process the groove 34 can be shortened, and production costs can be reduced.

Furthermore, because the groove 36 which forms the flow channel 37 is formed at the center of the top face 35a of the protrusion 35, the load applied to the cover 33 when the main body 32 and the cover 33 are joined can be transmitted to the bottom face 34a of the groove 34, that is the main body 32, via the edges of the protrusion 35 whose height is substantially equal to the depth of the groove 34, intrusion of the penetration bead of the weld into the flow channel 37 can be prevented, and deformation of the cover 33 resulting from the welding process can be prevented.

In addition, because the edges of the protrusion 35 are formed so as to have a height substantially equal to the depth of the groove 34, the rigidity of the cover 33 in its entirety can be improved, the width of the groove 36 can be increased, and the width of the flow channel 37 can be increased, thereby enabling an increase in the cross-sectional area of the flow channel 37.

In this embodiment, after joining the main body 32 and the cover 33, the top face (surface) of the cover 33 is uniformly (evenly) ground and polished until the entire surface 32a of the main body 32 is exposed, that is, until the top face of the cover 33 becomes flush with the top face 32a of the main body 33 (forms a coplanar surface). This process can also be used to reduce the overall plate thickness.

Furthermore, the heat exchanger plate according to the present invention is not one that is applicable only to the backing plate described for the aforementioned embodiments, and is also applicable to one which has a similar construction and function in an array forming process.

What is claimed is:

1. A manufacturing method for a heat exchanger plate comprising joining by friction stir welding:
a flat main body on a surface of which is formed at least one first groove having a rectangular cross-sectional shape, and a second groove having a rectangular cross-sectional shape that is narrower than said first groove, and that is formed following along opposite side faces of said first groove at a center of a bottom face of said first groove; and
a flat cover which covers an entire surface of said main body, and on a rear face of which is formed a protrusion whose top face contacts a bottom face of said first groove and whose opposite side faces contact opposite side faces of said first groove, when the cover is superposed on the surface of said main body, and which forms a flow channel by means of a top face thereof and said second groove.

2. A manufacturing method for a heat exchanger plate comprising joining by friction stir welding:
a flat main body on a surface of which is formed at least one groove having an approximately rectangular cross-sectional shape; and
a flat cover which covers an entire surface of said main body, and on a rear face of which is formed a protrusion whose opposite side faces contact opposite side faces of said groove, when the cover is superposed on the surface of said main body, and which forms a flow channel by means of a top face thereof, and a bottom face and opposite side faces of said groove.

3. A manufacturing method for a heat exchanger plate according to claim 2, wherein there is further provided a step for producing a notch that is concave inward, on the side faces of said protrusion facing the side faces of said groove when said protrusion is fitted to inside said groove, as at least a single line or a plurality of points along the side faces of said protrusion.

4. A manufacturing method for a heat exchanger plate comprising joining by friction stir welding:
a flat main body on a surface of which is formed at least one first groove having an approximate trapezoidal shape in cross-section, and a second groove having a rectangular cross-sectional shape that is further deepened along opposite side faces of said first groove between the side faces of said first groove; and
a flat cover which covers an entire surface of said main body, and on a rear face of which is formed a protrusion whose opposite side faces contact the opposite side faces of said first groove, when the cover is superposed on the surface of said main body, and which forms a flow channel by means of a top face thereof and a bottom face and opposite side faces of said second groove.

5. A manufacturing method for a heat exchanger plate comprising joining by friction stir welding:
a flat main body on a surface of which is formed at least one first groove having a rectangular cross-sectional shape; and
a flat cover which covers an entire surface of said main body, and on a rear face of which is formed a protrusion whose top face contacts a bottom face of said first groove, when the cover is superposed on the surface of said main body, and whose opposite side faces contact opposite side faces of said first groove, and which is provided with a second groove formed following along said opposite side faces at a center of said top face.

6. A manufacturing method for a heat exchanger plate according to claim 1, wherein a step is further provided after joining said main body and said cover, for uniformly grinding and polishing the surface of said cover until the surface of said cover becomes flush with the surface of said main body.

7. A heat exchanger plate comprising:
a flat main body on a surface of which is formed at least one first groove having a rectangular cross-sectional shape, and a second groove having a rectangular cross-sectional shape that is narrower than said first groove, and that is formed following along opposite side faces of said first groove at a center of a bottom face of said first groove; and
a flat cover which covers an entire surface of said main body, and on a rear face of which is formed a protrusion whose top face contacts a bottom face of said first groove and whose opposite side faces contact opposite side faces of said first groove, when the cover is superposed on the surface of said main body, and which forms a flow channel by means of a top face thereof and said second groove,
and said cover is joined by friction stir welding to said main body.

8. A heat exchanger plate comprising:
a flat main body on a surface of which is formed at least one groove having an approximately rectangular cross-sectional shape; and
a flat cover which covers an entire surface of said main body, and on a rear face of which is formed a protrusion whose opposite side faces contact opposite side faces of said groove, when the cover is superposed on the surface of said main body, and which forms a flow channel by means of a top face thereof and a bottom face and opposite side faces of said second groove,
and said cover is joined by friction stir welding to said main body.

9. A heat exchanger plate according to claim 8, wherein a notch that is concave inward, is arranged on the side faces of said protrusion facing the side faces of said groove when said protrusion is fitted to inside said groove, as at least a single line or a plurality of points along the side faces of said groove.

10. A heat exchanger plate comprising:
a flat main body on a surface of which is formed at least one first groove having an approximate trapezoidal shape in cross-section, and a second groove having a rectangular cross-sectional shape that is further deepened along opposite side faces of said first groove between the side faces of said first groove; and
a flat cover which covers an entire surface of said main body, and on a rear face of which is formed a protrusion whose opposite side faces contact the opposite side faces of said first groove, when the cover is superposed on the surface of said main body, and which forms a flow channel by means of a top face thereof and a bottom face and opposite side faces of said second groove,
and said cover is joined by friction stir welding to said main body.

11. A heat exchanger plate comprising:
a flat main body on a surface of which is formed at least one first groove having a rectangular cross-sectional shape; and
a flat cover which covers an entire surface of said main body, and on a rear face of which is formed a protrusion whose top face contacts a bottom face of said first groove, when the cover is superposed on the surface of said main body, and whose opposite side faces contact opposite side faces of said first groove,
and in said cover there is provided a second groove formed following along said opposite side faces at a center of said top face, and said cover is joined by friction stir welding to said main body.
